(19) United States
(12) Patent Application Publication
(10) Pub. No.: US 2009/0211555 A1
(43) Pub. Date: Aug. 27, 2009

(54) Carburetor for a Combustion Engine, and Method for the Controlled Delivery of Fuel

(75) Inventors: Martin Fischer, Schwabach (DE); Lars Ottosson, Tösse (SE)

Correspondence Address: LERNER GREENBERG STEMER LLP, P O BOX 2480, HOLLYWOOD, FL, 33022-2480, US

(73) Assignees: BING POWER SYSTEMS GMBH, Nurnberg (DE); R.E. PHELON COMPANY, INC., Aiken, SC (US)

(21) Appl. No.: 12/096,850

(22) PCT Filed: Dec. 8, 2006
(86) PCT No.: PCT/EP2006/011839

§ 371 Date: Sep. 24, 2008

(30) Foreign Application Priority Data
Dec. 10, 2005 (DE) 10 2005 059 080.2

(51) Int. Cl. F02M 25/07; C10J 1/12

(52) U.S. Cl. 123/437; 261/78.1

(57) ABSTRACT

In order to allow fuel to be delivered in a controlled manner into a mixing chamber of a carburetor, a needle is displaced towards a needle seat between an open and a closed position in a clocked manner relative to an intake stroke of the engine such that the amount of fuel that flows into the mixing chamber via a fuel duct is controlled in accordance with the rotational speed and the engine load.

The invention relates to a carburetor for an internal combustion engine, with a mixing chamber, which has a filter-side inlet for air and an engine-side outlet for a fuel-air mixture and into which a fuel duct opens at an orifice opening, in which duct a tapering needle is displaceable in such a way that the delivery of fuel into the mixing chamber is controlled. The invention further relates to a method for the controlled delivery of fuel into the mixing chamber of such a carburetor.

In the operation of the internal combustion engine such a carburetor draws in ambient air via a filter, owing to the negative pressure generated. The negative pressure at the same time causes fuel to flow via the fuel duct, which is also referred to as the mixing tube, into the mixing chamber, where together with the air it forms a fuel-air mixture, which flows into a combustion chamber of the engine. A throttle valve is arranged in the carburetor on the engine side. Since in such a carburetor the fuel is drawn in due to the negative pressure, a controlled or regulated delivery of fuel into the mixing chamber for optimum load and rotational speed is possible only with difficulty, if at all.

In order to be able to adhere to statutory exhaust standards, a fuel injection system is provided on passenger cars. This is comparatively costly and intricate, however. In the case of small engines, like those used for (small) motorcycles and work appliances such as chain saws or lawnmowers, for example, carburetors are used as these are more cost-effective than injection systems. The statutory exhaust requirements for these small engines are less critical, although they are increasingly also being tightened up for small engines.

DE 102 18 084 A1 discloses a carburetor, in which a piezo element is used to control or regulate the flow cross section of a fuel jet for the fuel delivery. Such a fuel jet is usually connected upstream of the fuel duct in the direction of flow of the fuel. U.S. Pat. No. 5,809,971 discloses a carburetor, the fuel delivery of which is blocked by a solenoid valve and regulated by a further operating element.

CH 216038 A and BE 406646 A provide for a needle, which adjusts the flow cross section of the fuel jet as a function of the throttle valve position in order to control the fuel delivery. DE 2529663 A1 and DE 8510540 U1 each disclose carburetors, in which a needle is again used to control the fuel delivery, said needle being controlled as a function of the lambda value and being adjusted only between two defined rates of flow or being continuously adjustable by means of a servomotor.

The object of the invention is to provide a control of simple and reliable design for the delivery of fuel into the mixing chamber of a carburetor.

According to the invention the object is achieved by the features of patent claim 1. According to this, a needle is controllably displaced in the fuel duct as a function of the engine load and the rotational speed. The needle is here controlled by means of a suitably designed control unit in such a way that the needle runs into a closed position when the crankshaft reaches a specific position and runs back into an open position at a subsequent position of the crankshaft. The crankshaft positions at which the valve opens or closes are calculated and defined by the control unit as a function of the engine load and the rotational speed. For this purpose the control unit refers to suitable input variables correlated with the engine load and the rotational speed. The valve displacement between the closed position and the open position is therefore timed with regard to a prevailing engine intake stroke. The two crankshaft positions, between which the valve is situated in the closed position, usually lie within an engine intake stroke. The crankshaft positions in which the valve closes may also occur prior to the start of the intake stroke. The subsequent crankshaft position, in which the valve opens again, may in principle also occur after completion of the intake stroke.

This timed mode of operation gives rise to a so-called closing window, that is to say a period of time in which the otherwise open fuel duct is closed. The length of this closing window or also its position in relation to a prevailing engine intake stroke determines the fuel delivery. The length of time is here determined by the angle of rotation of the crankshaft. The timing is also determined by the angle of rotation of the crankshaft. The control unit is therefore designed in such a way that it closes or opens the valve at specific rotational positions of the crankshaft during two full revolutions of the crankshaft (four-stroke engine). These specific rotational positions of the crankshaft are controlled as a function of the engine load and the rotational speed. In the case of a two-stroke engine this occurs during one full revolution of the crankshaft.

The rotational speed of the engine is here defined by the number of revolutions of the crankshaft. The engine load is substantially determined by the opening angle of the throttle valve.

The needle is here displaced exclusively between the closed position and the open position. To regulate the delivery of fuel, the needle is therefore timed as it runs towards the needle seat, the period of time during which the needle remains in the closed position being controlled. The delivery of fuel is controlled via the closing times of the needle in the needle seat in relation to an engine intake stroke. In this timed operating mode the overall flow of fuel is adjusted to the consumption pattern of the engine through periodic opening and closing in conjunction with the regulated opening and closing time. In this operating mode several thousand closing sequences per minute, for example 3,000 closing sequences per minute, often occur according to the rotational speed of the engine. The valve timing gear therefore responds very rapidly. In a four-stroke engine the solenoid valve is closed once for a predetermined period of time and at a defined point in time in each control cycle, which spans the four working strokes of the engine, (and hence every two revolutions of the engine crankshaft).

This timed displacement of the needle between two discrete positions therefore makes it possible, for a low design and control engineering cost, to set a lean fuel-air mixture with a low proportion of fuel or a rich mixture with a high proportion of fuel, as necessary. Thus it is also possible, for example, particularly by controlling the delivery of fuel, to improve the acceleration behavior of the engine by setting a rich mixture.

According to an appropriate development a solenoid valve, in particular, is provided as controllable actuator for actuation of the needle. Such an actuator readily affords a comparatively large adjustment travel
especially compared to a piezo-electric operating element—so that the fuel can easily be proportioned. Moreover, this type of actuator is easy to control. The solenoid valve here permits a very rapid adjustment of the fuel delivery as a function of the engine cycle. A solenoid valve is moreover a shut-off valve tried and tested in many applications.

According to a preferred development the actuator is arranged on the side of the mixing chamber opposite the orifice opening. An operating element, such as a tappet, for example, operated by the actuator and acting on the needle, is here in particular led through the mixing chamber. The needle or the tappet is therefore introduced into the fuel duct from outside via the orifice opening. This has the particular advantage that an homogeneous fuel flow can form, avoiding any unwanted pumping effect. Such a pumping effect might in fact occur if the needle or the tappet were to be moved in the fuel-filled area inside the fuel duct, so that a forward movement of the needle in the fuel duct would cause fuel to be pumped towards the orifice opening, or in returning would draw fuel away from the orifice opening.

The needle and the needle seat are preferably of conical design, in order to ensure smooth, reliable opening and closing. They are matched to one another so as to allow a tight sealing of the fuel duct.

In an appropriate development the needle seat is arranged in the fuel duct at an interval from the orifice opening. This measure allows the fuel duct in the front area oriented towards the orifice opening to be designed in the nature of a mechanical guide for the needle.

A non-return valve is preferably arranged in the fuel duct in this area and preferably directly at the orifice opening where the fuel duct opens into the mixing chamber. This serves to prevent any unwanted return flow of air or an air-fuel mixture into the fuel duct. A highly accurate proportioning of fuel is thereby achieved despite the closing point (needle seat) being arranged at a distance from the orifice.

In order to avoid damage to the needle and the needle seat in the timed, discontinuous mode of operation, due to the frequent closing sequences, according to an appropriate development at least the surface of the needle and that of the needle seat is hardened. The entire needle is here preferably composed of hardened steel. The fuel duct is composed of steel and is preferably also hardened throughout. The fuel ducts used in standard carburetors are usually composed of brass and are not suitable for the frequent opening and closing. Alternative materials may also be provided for continuous operation.

In standard carburetors a further, secondary duct, via which an essential quantity of fuel is delivered for idling, that is to say when the throttle valve is closed, is generally provided in addition to the fuel duct. This secondary duct will hereinafter be referred to as an idling duct. The idling duct partly forms a bypass system in order to deliver an additional quantity of fuel to the mixing chamber in the lower partial load range. According to a preferred development the fuel delivery passing via the idling duct is also controllable. For this purpose a further adjusting or closing element is provided, for example, such as a further needle, which varies the open flow cross section of the idling duct.

However, the control is appropriately achieved by means of the needle that is also intended for controlling the main duel delivery via the fuel duct. This configuration means that only one operating unit, comprising the actuator and the needle, is required, thereby minimizing the design effort and hence the cost.

The idling duct here preferably opens into the fuel duct, downstream of the valve seat in the direction of flow of the fuel. The open flow cross section for the fuel and hence the quantity of fuel flowing through is varied through the interaction of the needle with the needle seat. The fuel in the fuel duct flowing through the valve seat enters the idling duct and is as usual delivered to the carburetor on the engine side downstream of the throttle valve. This configuration exploits the fact that in idling the throttle valve is virtually closed and the idling duct opens out on the side of the throttle valve facing the internal combustion engine, that is to say in an area in which negative pressure prevails. The fuel is thereby drawn in via the idling duct. At the same time, a negative pressure does not prevail in the central part of the mixing chamber, which is formed on the side of the throttle valve remote from the internal combustion engine, so that no fuel is drawn into the central part of the mixing chamber.

According to an appropriate development a regulated bypass system is provided, by means of which a controlled delivery of fuel can be fed into the mixing chamber in addition to the fuel delivery via the fuel duct. The bypass system here has a further orifice opening into the mixing chamber, via which fuel can be drawn into the mixing chamber due to the negative pressure prevailing on the engine side. The control and regulating facility means that additional fuel can be delivered as a function of the current load demands, for example in order to enrich the mixture in partial load operation, when the engine is cold or in acceleration sequences.

The bypass system can preferably be controlled together with the idling system, that is to say it forms, together with the latter, a combined idling and bypass system. For this purpose at least one branch duct branching off the idling duct is provided, which opens into the mixing chamber upstream of the throttle valve. In order to control the combined system, either a separate operating element or control valve is provided or regulation is achieved via the needle together with regulation of the fuel delivery through the fuel duct.

In order to prevent a return flow of fuel through the idling duct and/or through the bypass system, according to an appropriate development a non-return valve, in the form of a simple mechanical check valve, for example, is arranged in the idling duct and/or in the bypass system.

A further, non-controllable idling duct is preferably provided. This is preferably designed in such a way that an essential, minimum delivery of fuel via this duct is assured. Additional fuel is then delivered, as required, via the controllable idling duct. The further, non-controllable idling duct is here dimensioned in such a way, for example, that the correct quantity of fuel is delivered when the engine is warm or a slightly lean quantity of fuel is delivered when idling. The further, non-controllable idling duct appropriately forms an unregulated bypass system.

In order to minimize the design outlay and hence the costs, the needle is furthermore appropriately also designed for shutting off the fuel delivery, that is to say the control unit controls the needle in such a way that it is securely held in a tight position against the needle seat. The system described here for controlling the delivery of fuel therefore fulfils a dual function. On the one hand the delivery of fuel is controlled during engine operation, and on the other the delivery of fuel into the mixing chamber is shut off when the engine is switched off. No further closing element is therefore provided for shutting off the delivery of fuel.

According to the invention the object is further achieved by a method having the features of claim 16. The advantages and preferred embodiments cited in respect of the carburetor are also transferred analogously to the method.

Exemplary embodiments of the invention are explained in more detail below with reference to the drawings. These each show schematic and greatly simplified representations in the nature of cross sectional diagrams.

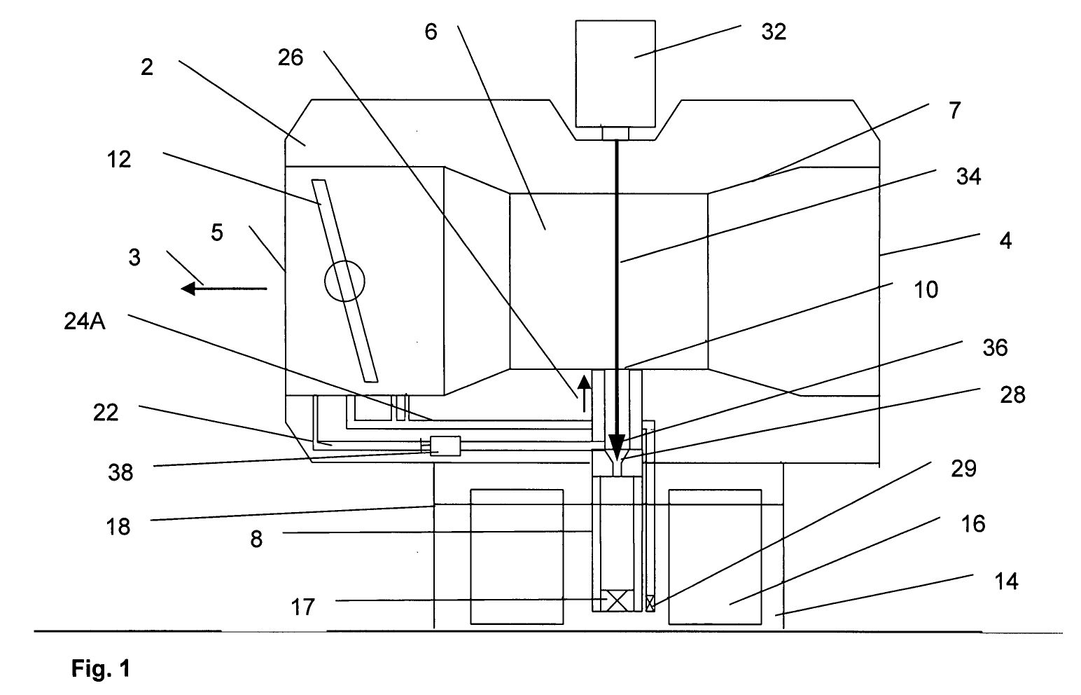

FIG. 1. shows a carburetor with a regulated idling system and an unregulated idling and bypass system,

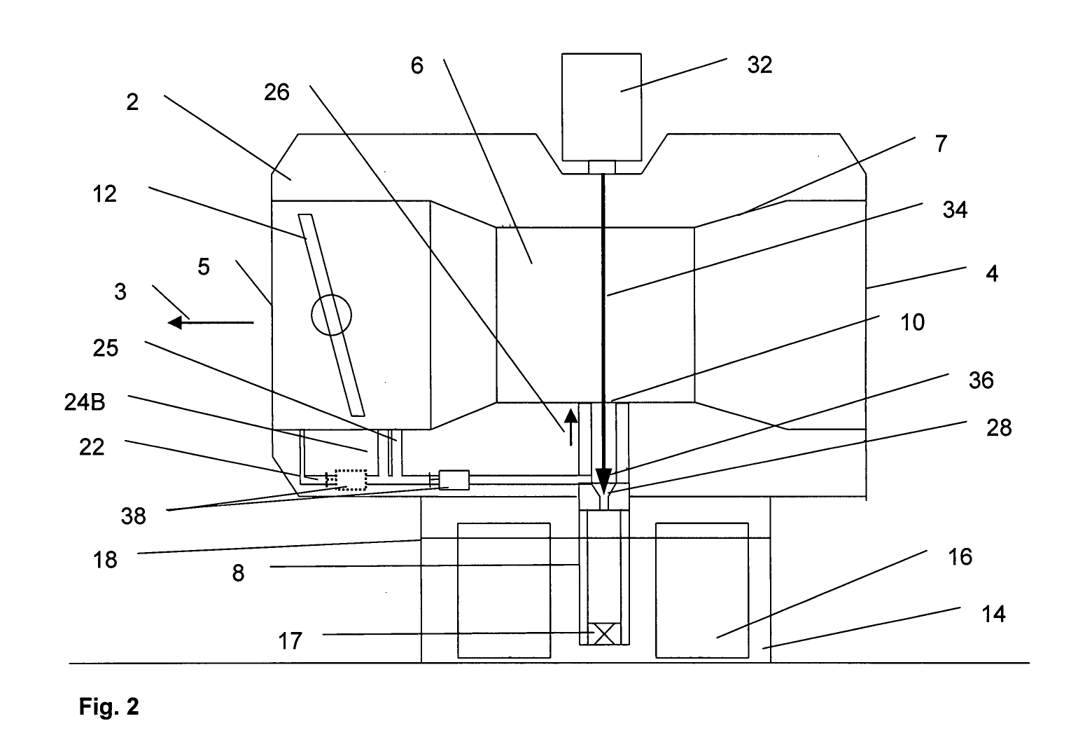

FIG. 2. shows a carburetor with a regulated idling and bypass system, and

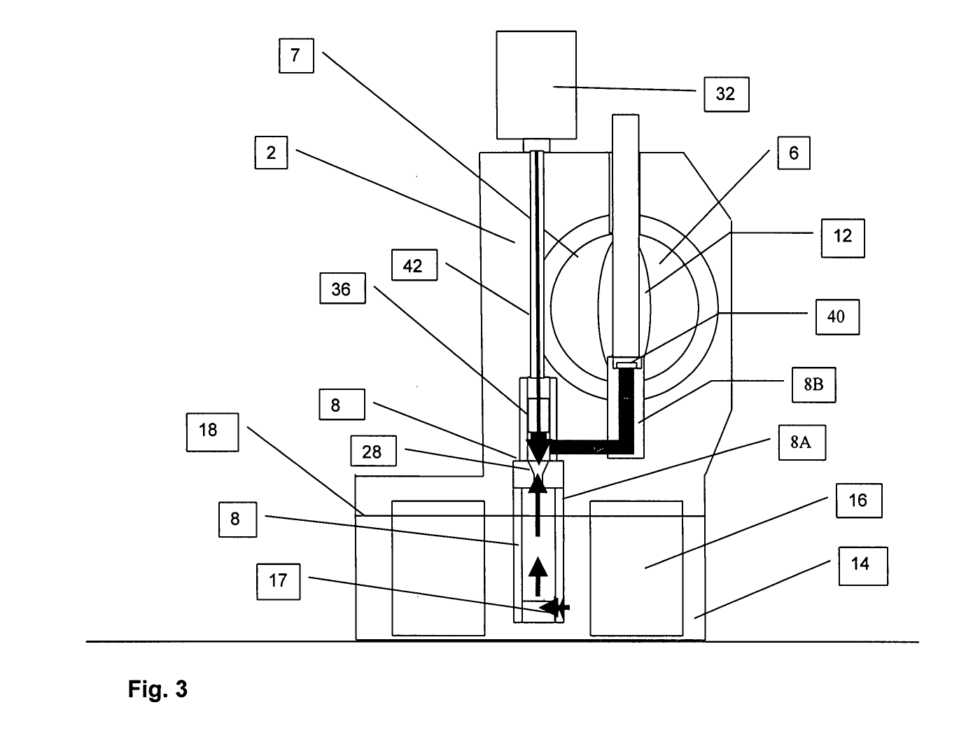

FIG. 3. shows a carburetor with a non-return valve at an orifice opening into the mixing chamber, viewed in the longitudinal direction of a mixing tube.

In the drawings, parts performing an equivalent function are provided with the same reference numerals.

The carburetor comprises a carburetor housing 2, in which a mixing tube 7 is arranged extending in the direction of flow 3 from a filter-side inlet 4 for air to an engine side outlet 5 for a fuel-air mixture. The mixing tube 7 takes the form of a Venturi tube having a middle area with a reduced diameter. The mixing tube 7 encloses a mixing chamber 6. A fuel duct 8 opens into its central part at an orifice opening 10. In operation, fuel is drawn into the mixing chamber 6 via this opening and is mixed with the intake air to form the fuel-air mixture. In operation, air flows through the carburetor on the intake side and the fuel-air mixture on the engine side viewed in the direction of flow. The fuel flows in via the fuel duct 8, denoted as the mixing tube, perpendicular to the direction of flow 3. A throttle valve 12 is arranged close to the outlet 4.

A float chamber 14 with a float 16 is arranged below the mixing tube 7. In operation, the fuel delivered from the fuel tank is situated in the float chamber 14. The fuel duct 8 opens into the float chamber 14. A main jet 17 is here provided at the orifice. The float chamber 14 is filled with fuel up to a fuel level 18.

In the exemplary embodiment in FIG. 1 a first idling duct 22 and a second idling duct forming a bypass system 24A are provided in addition to the central fuel duct 8. The first idling duct 22 here opens into the fuel duct 8 above a needle seat 26 in the direction of flow 26 of the fuel. At its second orifice opening the first idling duct 22 opens into the mixing tube 7, that is downstream of the throttle valve 12 in the direction of flow 3. By contrast the second idling duct 24A at one end opens into the float chamber 14. An idling jet 29 is here provided in the orifice area. At its other end the second idling duct 24 has multiple orifice openings into the mixing tube 7. In the exemplary embodiment one orifice opening is assigned to the outlet side of the throttle valve 12 in the direction of flow 3, and two further, smaller orifice openings are arranged upstream of the throttle valve 12 in the direction of flow 3. The second idling duct 24A therefore partly forms a type of bypass system. The two orifice openings arranged upstream of the throttle valve 12 in the direction of flow here serve for the supplementary delivery of fuel in partial load operation, that is with the throttle valve partially opened, in order to ensure optimum engine running in partial load operation.

In the exemplary embodiment in FIG. 2, by contrast, only a combined, regulated idling and bypass system is provided. In this case two branch lines 25, which form the bypass system and open into the mixing tube 7 upstream of the throttle valve 12 in the direction of flow 3, branch off from the first idling duct 22.

It is now of particular importance that the carburetor represented here is designed for controlled and in particular regulated delivery of fuel into the mixing chamber 6 as a function of the engine load. For this purpose an actuator 32 is provided, which acts on a conical needle 36 by way of a operating element 34. The actuator 32 is in particular a solenoid valve. The operating element 34 is in particular a tappet, on which the needle 36 is fixed or formed at the end. The actuator 32 is arranged on the side of the carburetor housing 2 opposite the float chamber 14. The operating element 34 is led through the mixing chamber 6 (FIGS. 1, 2) or past the mixing chamber 6 (cf. FIG. 3) and into the fuel duct 8. This arrangement of the actuator 32 means that the entire control mechanism, comprising the actuator 32, the operating element 34 and the needle 36, is therefore arranged outside the fuel delivery. This avoids any pumping effect under a movement of the needle 36.

The needle 36, shown greatly simplified in the drawings, is of conical or tapered design. The needle seat 28 is also of conical or truncated cone design.

The needle seat 28 is here arranged at an interval from the orifice opening 10 and thereby divides the fuel duct 8 into a front area facing the mixing chamber 6 and a rear area merging into the float chamber 14. The fuel flows via the needle seat 28 from the rear area into the front area and via the orifice opening 10 into the mixing chamber 6, provided that the needle 36 is not situated in a closed position, in which a delivery of fuel via the needle seat 28 is prevented.

For the controlled delivery of fuel, the needle 36 is displaced by the operating element 34 in the longitudinal direction of the fuel duct 8, that is to say in the direction of flow 26 of the fuel. Two different operating modes are in principle provided therefor.

In operation, the displacement of the needle 36 between a closed and an open position is timed, the needle 36 here being actuated up to several thousand times per minute, depending on the rotational speed of the engine. At each second revolution of the crankshaft of the four-stroke engine the needle 36 is here only closed at the respective induction point. The delivery of fuel is here controlled via the setting for the duration of the closing period. At each intake stroke, therefore, the valve goes into a closed position for a specific period of time. Both the duration and the point in time when the valve goes into its closed position (and back into its open position) are set by the control unit as a function of the engine load and the rotational speed. A suitable quantity of fuel is therefore in each case provided for the respective cylinder or combustion chamber of the engine as a function of the prevailing requirements for each intake stroke. The partial or complete shifting of the closing period within the intake stroke is a preferred way of exerting an additional beneficial influence on the mode of operation of the engine.

In order to avoid wear to the needle 36 and the needle seat 28 due to the high timing rates of the closing sequences, their surfaces at least are hardened. The needle 36 and the needle seat 28 are moreover made of steel. The entire fuel duct 8 is embodied as a steel tube. For this discontinuous mode of operation, a solenoid valve is preferably provided as actuator 32.

For controlling the actuator, a control device (not shown here) is provided, which delivers corresponding control signals to the actuator 32 as a function of the engine load.

In addition to the delivery of fuel into the mixing chamber 6, the first idling duct 22, via which a regulated delivery of fuel also occurs, is also intended for idling. Since this duct opens into the upper area of the fuel duct 8 and hence downstream of the needle seat 28 in the direction of flow 26 of the fuel, this allows the delivery of fuel via the first idling duct to be likewise regulated by means of the needle 36.

During operation, a negative pressure, which serves to draw the fuel out of the float chamber 14 via the fuel duct 8 and/or the second idling duct 24A (FIG. 1), prevails on the engine side, that is to say at the outlet 5. Different partial flows are formed depending on the position of the throttle valve 12 and the arrangement of the respective orifice openings. With the throttle valve 12 closed, a negative pressure does not prevail at the orifice opening 10, so that fuel only flows into the mixing tube 7 via the first and second idling duct 22, 24A in the area of the outlet 5. Actuation of the needle 36 here serves to regulate the quantity of fuel delivered via the first idling duct 22.

Instead of this system shown in FIG. 1, with a regulated idling duct 22 and an unregulated idling duct 24A (bypass system), according to FIG. 2 just one single, regulated idling duct 22 is alternatively provided, from which branch ducts 25 branch off to form a regulated bypass system 24B. The bypass system 24B is here regulated together with the regulation of the idling system provided via the idling duct 22.

In operation, there is the possibility of a variation in the pressure ratios occurring in the mixing tube 7 due to opening of the throttle valve 12. Opening the throttle valve 12 in fact causes the pressure to increase gradually downstream of the valve in the direction of flow 3 and to fall in the area of the central mixing chamber 6, formed in the manner of a Venturi tube, due to the increased flow speed. There is therefore the risk that the fuel-air mixture present in the mixing tube 7 in the area of the throttle valve 12 will thereby be drawn in via the idling duct 22 and/or the bypass system 24B in the area of the throttle valve 12, and will flow to the fuel duct 8, where it might interfere with intake of fuel from the fuel duct 8. In order to prevent this, in the exemplary embodiments a non-return valve 38, which, although it allows the fuel to pass in one direction, prevents the return flow of air, is incorporated into the idling duct 22. In FIG. 2 two possible fitting positions are drawn in, the non-return valve 38 represented merely by dashed lines only safeguarding the idling duct 22, whereas the non-return valve 38 represented by solid lines safeguards the idling duct and the branch ducts 25 of the bypass system 24B.

As an alternative to the variant represented here, in which the needle 36 serves to regulate both the main fuel delivery into the mixing chamber 6 via the orifice opening 10 and the delivery of fuel via the first idling duct 22, two separate operating systems are provided both for the regulated idling system and for the main fuel supply. Finally, a further operating system may be provided for the regulated bypass system 24B. In this case, or where a regulated idling system is dispensed with, the needle seat 28 may be formed directly at the orifice opening 10.

According to FIG. 3 a further non-return valve 40 is finally arranged as an additional feature directly at the orifice opening 10. The operating element 34 is here led past the mixing chamber 6 inside a guide 42. The fuel duct 8 is sub-divided into a front area 8A leading to the float chamber 14 and a rear area 8B leading to the mixing chamber 6. The rear area 8B is arranged downstream of the needle seat 28 in the direction of flow of the fuel and is aligned at an angle to the front area 8A. The idling duct 22 visible in FIGS. 1 and 2 also branches off at this point (running into the plane of projection, as represented in FIG. 3). In the exemplary embodiment the rear area 8B is of L-shaped design. Due to the communicating fuel ducts 8B and 22 downstream of the needle seat, there might be a risk, even with the valve in the closed position, of air getting into the area of the needle seat 28, and mixing additional air into the idling fuel when idling. The further non-return valve 40, which may also take the form of a check valve, serves to prevent this. All in all, the further non-return valve 40 serves to improve the proportioning accuracy in the delivery of fuel, especially when idling.

### List of Reference Numerals

2 carburetor housing
3 direction of flow
4 inlet
5 outlet
6 mixing chamber
7 mixing tube
8 fuel duct
8A front area
8B rear area
10 orifice opening
12 throttle valve
14 float chamber
16 float
17 main jet
18 fuel level
22 first idling duct
24A second idling duct (unregulated bypass system)
24B regulated bypass system
25 branch duct
26 direction of flow of the fuel
28 needle seat
29 idling jet
32 actuator
34 operating element
36 needle
38 non-return valve
40 further non-return valve
42 guide

1-17. (canceled)

18. A carburetor for an internal combustion engine, comprising:
a mixing chamber formed with a filter-side inlet for air and with an engine-side outlet for a fuel-air mixture;
a fuel duct opening into an orifice opening into said mixing chamber;
a needle displaceably mounted between an open position and a closed position against a needle seat for controlling a delivery of fuel through said fuel duct into said mixing chamber, wherein said needle is controlled to time a displacement thereof between the open position and the closed position in dependence on a rotational speed of the engine and an engine load with reference to a respective intake stroke of the engine.

19. The carburetor according to claim 18, wherein a timed displacement of said needle defines a closing window, during which said fuel duct is closed, and wherein a timed length of the closing window in relation to the prevailing intake stroke is determined by an angle of rotation of a crankshaft of the internal combustion engine.

20. The carburetor according to claim 18, which comprises a solenoid valve forming a controlled actuator for actuating said needle.

21. The carburetor according to claim 20, wherein said actuator is disposed opposite said orifice opening.

22. The carburetor according to claim 18, wherein said needle seat is formed in said fuel duct at a spacing distance from said orifice opening.

23. The carburetor according to claim 18, which comprises a check valve disposed in a region of said orifice opening into said mixing chamber.

24. The carburetor according to claim 18, wherein said needle and said needle seat are formed with a hardened surface.

25. The carburetor according to claim 18, which further comprises an idling duct for the fuel, said idling duct opening into said mixing chamber downstream of a throttle valve in a direction of flow of the fuel-air mixture, and wherein a delivery of fuel through the idling duct is controllable.

26. The carburetor according to claim 25, wherein said needle is disposed to also control the delivery of fuel via said idling duct.

27. The carburetor according to claim 25, wherein said idling duct opens into said fuel duct downstream of said valve seat in a direction of flow of the fuel.

28. The carburetor according to claim 18, which comprises a bypass system for a controlled delivery of fuel into said mixing chamber in addition to a delivery of fuel via said fuel duct.

29. The carburetor according to claim 25, which further comprises an idling duct for the fuel, said idling duct opening into said mixing chamber downstream of a throttle valve in a direction of flow of the fuel-air mixture, and wherein a delivery of fuel through the idling duct is controllable, and wherein a combined idling and bypass system is formed with at least one branch duct branching off from said idling duct and opening into said mixing chamber upstream of said throttle valve.

30. The carburetor according to claim 29, which comprises at least one check valve disposed in said idling duct and/or in said bypass system.

31. The carburetor according to claim 29, which comprises a further, non-controllable idling duct.

32. The carburetor according to claim 18, which comprises a fuel jet disposed in said fuel duct upstream of said needle seat in a direction of flow of the fuel.

33. The carburetor according to claim 18, wherein said needle is configured to selectively shut off a delivery of fuel.

34. A method for the controlled delivery of fuel into a mixing chamber of a carburetor, the mixing chamber having a filter-side inlet for air and an engine-side outlet for a fuel-air mixture and a fuel duct opening into the mixing chamber at an orifice opening, the method which comprises:
providing a needle displaceably mounted between an open position and a closed position against a needle seat;
controlling a displacement of the needle between the open position and the closed position against the needle seat in dependence on a rotational speed of the engine and an engine load, and timed with reference to a prevailing intake stroke.
